(19) United States
(12) Patent Application Publication
(10) Pub. No.: US 2009/0244785 A1
(43) Pub. Date: Oct. 1, 2009

(54) MAGNETIC RECORDING MEDIUM, MAGNETIC RECORDING/REPRODUCTION DEVICE, AND METHOD OF MANUFACTURING MAGNETIC RECORDING MEDIUM

(75) Inventors: Hideyuki Kikuchi, Kawasaki (JP); Kenji Sato, Kawasaki (JP); Takuya Uzumaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/346,210

(22) Filed: Dec. 30, 2008

(30) Foreign Application Priority Data
Mar. 27, 2008 (JP) 2008-83488

(51) Int. Cl. G11B 5/56; G11B 5/82; B44C 1/22

(52) U.S. Cl. 360/294; 360/135; 216/22; G9B/5.293; G9B/5.201

(57) ABSTRACT

A magnetic recording medium suppresses effectively side erasure even when recording dot intervals are reduced. Magnetic dots and a soft magnetic layer are provided on a soft magnetic underlayer with a nonmagnetic layer intervening, so that magnetic dots are separated by the soft magnetic layer, and consequently leakage flux during recording to magnetic dots is absorbed by the soft magnetic layer, side erasure can be suppressed, and moreover the soft magnetic underlayer and soft magnetic layer are separated, so that an influence on recording/reproduction characteristics can be prevented.

### CROSS-REFERENCE TO RELATED APPLICATIONS

This application is based upon and claims the benefit of priority of the prior Japanese Patent Application No. 2008-83488, filed on Mar. 27, 2008, the entire contents of which are incorporated herein by reference.

### FIELD

The present invention relates to a magnetic recording medium, a magnetic recording/reproduction device, and a method of manufacturing a magnetic recording medium, for recording and reproducing data by magnetic heads, and in particular relates to a magnetic recording medium, a magnetic recording/reproduction device, and a method of manufacturing a magnetic recording medium, provided with magnetic recording dots which are physically separated.

### BACKGROUND

Bit patterned recording (BPR) methods have been proposed as next-generation ultra-high density perpendicular magnetic recording methods. The BPR methods are methods in which the hard magnetic material of the recording medium is machined to form a relief pattern, using photolithographic processes, etching processes, or similar to form protruding portions as recording bits, and recording and reproduction performed with each dot as one bit.

In this method, adjacent bits are separated both physically and magnetically, so that there is little magnetic interaction between bits, making the medium suited to high-density recording. Further, fine crystals are not required of the hard magnetic material forming the dots, so that excellent thermal stability (high reliability) is obtained.

FIG. 14 shows the configuration of a first patterned medium of the prior art, and FIG. 15 shows the configuration of a second patterned medium of the prior art.

As shown in FIG. 14, after applying resist onto a glass substrate on which a magnetic recording film has been deposited, and then forming a recording dot pattern and servo pattern in the resist, an etching process is used to remove a portion of the magnetic recording film to form the resist pattern onto the magnetic recording film 102. The resist is removed, portions removed by the etching process are buried by a nonmagnetic film 104, and finally flattening is performed to form the patterned medium 100. In a patterned medium fabricated by this method, dots 102 are partitioned by the nonmagnetic layer 104, and so are both magnetically and physically isolated, and the medium is suited to high-density recording (see Japanese Patent Laid-open No. 9-97419, Japanese Patent Laid-open No. 2005-267736).

As shown in FIG. 15, a patterned medium has been proposed in which, in order to integrally form a backing layer and nonmagnetic layer, fine soft magnetic particles including a polymer are imprinted by a pressing process onto the substrate 110, then this is subsequently heated to form a soft magnetic layer 106, and an under-layer and intermediate layer 108, and magnetic recording dots 102 are formed in depressions of the soft magnetic layer 106 (see for example Japanese Patent Laid-open No. 2004-227639).

This patterned medium has a structure in which the magnetic recording dots 102 are surrounded, on the periphery and below, by the soft magnetic layer 106.

Higher recording densities continue to be required of magnetic recording devices. Hence there are also demands for reduced dot intervals in a patterned medium.

FIG. 16 explains problems with the technology of the prior art. When dot intervals are made smaller, upon recording to a certain dot, a leakage magnetic field from the recording magnetic field of the magnetic head (write head) 110 affects adjacent dots 102, thereby causing magnetic data in the adjacent dots 102 to be erased. This so-called side erasure poses a problem. Upon reducing the dot intervals, it becomes necessary to lower the flying height of the write head 110, and it is difficult to avoid the occurrence of side erasure.

On the other hand, in a second patterned medium of the prior art, as shown in FIG. 17, since the soft magnetic film between bits and the soft magnetic film 106 below the recording layer 102 are continuous and integral, the magnetic coupling occurs between the soft magnetic layer between bits and the soft magnetic backing layer 106. Hence there is the concern that magnetic noise may occur during recording and reproduction. Moreover, after pattern formation, heat treatment is necessary to harden the fine soft magnetic particles, and so materials with excellent heat resistance must be selected as the substrate and underlayer materials.

That is, the magnetization direction in the soft magnetic film 106 between bits also moves easily by receiving the effect of the magnetization direction of the soft magnetic film 106 below the recording layer, which moves during recording, such as indicated by FIG. 16. Moreover, the magnetization direction in the soft magnetic film between bits tends to be oriented perpendicularly due to the film shape.

For these reasons, the magnetization direction in the soft magnetic film between recording bits is normally unstable, and advantageous reduction of side erasure cannot be expected. Moreover, there is an effect on the magnetization in the recording dots themselves, with the danger of an increase in the SN (Signal to Noise) ratio during reading.

### SUMMARY

Hence an object of the invention is to provide a magnetic recording medium, a magnetic recording/reproduction device, and a method of manufacture of a magnetic recording medium, to suppress effectively side erasure even when recording dot intervals are reduced.

Another object of the invention is to provide a magnetic recording medium, a magnetic recording/reproduction device, and a method of manufacture of a magnetic recording medium, to suppress effectively side erasure and to secure the magnetic separation of recording dots, even when recording dot intervals are reduced.

Still another object of the invention is to provide a magnetic recording medium, a magnetic recording/reproduction device, and a method of manufacture of a magnetic recording medium, to suppress effectively side erasure and to realize high-density recording, even when recording dot intervals are reduced.

To achieve the above-described objects, a magnetic recording medium according to the present invention includes: a substrate; a soft magnetic backing layer, provided on the substrate; a nonmagnetic layer, provided on the soft magnetic backing layer; a magnetic recording layer, which is provided on the nonmagnetic layer and formed from a hard magnetic material, and which has a plurality of physically separated magnetic dots; and a soft magnetic layer, provided on the nonmagnetic layer so as to surround the periphery of the magnetic dots of the magnetic recording layer.

Further, a magnetic recording/reproduction device according to the present invention, includes: a magnetic recording medium; an electromagnetic transducing element which reads data from and writes data to the magnetic recording medium; and an actuator, which moves the electromagnetic transducing element to an arbitrary position of the magnetic recording medium. And the magnetic recording medium includes: a substrate; a soft magnetic backing layer, provided on the substrate; a nonmagnetic layer, provided on the soft magnetic backing layer; a magnetic recording layer, which is provided on the nonmagnetic layer and formed from a hard magnetic material, and which has a plurality of physically separated magnetic dots; and a soft magnetic layer, provided on the nonmagnetic layer so as to surround a periphery of the magnetic dots of the magnetic recording layer.

Additionally, a method of manufacturing a magnetic recording medium according to the present invention, includes: a first step of depositing on a substrate a soft magnetic backing layer, nonmagnetic layer, and magnetic recording layer formed of a hard magnetic material; a second step of applying resist to the magnetic recording layer deposited on the substrate, and forming a pattern in the resist to form a plurality of physically separated magnetic dots; and a third step of forming a soft magnetic layer on the nonmagnetic layer so as to surround peripheries of the magnetic dots of the magnetic recording layer, by using either one of etching and ion milling through the patterned resist.

In addition, according to the present invention, it is preferable that a direction of an easy axis of magnetization in the soft magnetic layer is parallel to the substrate, and a direction of an easy axis of magnetization in the magnetic recording layer is perpendicular to the substrate.

Further, according to the present invention, it is preferable that a nonmagnetic member is provided at a boundary between the magnetic dots and the soft magnetic layer.

Furthermore, according to the present invention, it is preferable that a coercive force of the soft magnetic layer is smaller than a coercive force of the magnetic recording layer.

Additionally, according to the present invention, it is preferable that the magnetic recording layer includes a perpendicular magnetization film.

In addition, according to the present invention, it is preferable that the magnetic recording medium includes a magnetic disk, and the electromagnetic transducing element includes a read element which reads data from the magnetic disk and a write element which writes data to the magnetic disk.

Additionally, according to the present invention, it is preferable that the third step has a step of etching the magnetic recording layer through the patterned resist, a step of stripping away the resist, and a step of forming a soft magnetic layer on the nonmagnetic layer so as to surround peripheries of the magnetic dots of the magnetic recording layer.

Further, according to the present invention, it is preferable that the third step has a step of ion implantation of nonmagnetic material atoms into the magnetic recording layer through the patterned resist, to modify the layer to soft magnetic material, and a step of stripping away the resist.

Furthermore, according to the present invention, it is preferable that the step of forming the soft magnetic layer has a step, with respect to the magnetic recording layer subjected to the etching, of forming the nonmagnetic material and the soft magnetic material on the nonmagnetic layer so as to surround peripheries of the magnetic dots of the magnetic recording layer.

Specifically, according to the present invention, it is preferable that the step of etching the magnetic recording layer has a step of using an ion milling method to abrade the hard magnetic material and lower nonmagnetic material through the resist, and of causing re-adhesion of nonmagnetic material, occurring at the time of milling of the lower nonmagnetic material, to side walls of the pattern formed in the magnetic recording layer, and forming the nonmagnetic material on peripheries of the magnetic dots.

Magnetic dots and a soft magnetic layer are provided on a soft magnetic underlayer with a nonmagnetic layer intervening, so that magnetic dots are separated by the soft magnetic layer, and consequently leakage flux during recording to magnetic dots is absorbed by the soft magnetic layer, side erasure can be suppressed, and moreover the soft magnetic underlayer and soft magnetic layer are separated, so that an influence on recording/reproduction characteristics can be prevented.

Additional objects and advantages of the invention (embodiment) will be set forth in part in the description which follows, and in part will be obvious from the description, or may be learned by practice of the invention.

The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is an external view of one embodiment of a magnetic recording/reproduction device of one embodiment according to this invention;

FIG. 2 is a cross-sectional view of a first embodiment of a magnetic recording medium of the invention;

FIG. 3 is a perspective view of the magnetic recording medium in FIG. 2;

FIG. 4 explains the side erasure suppression effect of the configuration in FIGS. 2 and 3;

FIG. 5 explains magnetic flux in perpendicular recording of a magnetic recording medium in FIGS. 2 and 3;

FIG. 6 explains the magnetization direction for the configuration in FIG. 2;

FIG. 7 is a perspective view of a second embodiment of a magnetic recording medium of this invention;

FIG. 8 is a cross-sectional view of the magnetic recording medium in FIG. 7;

FIG. 9 shows processes in a first embodiment of a method of manufacture of a magnetic recording medium of this invention;

FIG. 10 shows processes in a second embodiment of a method of manufacture of a magnetic recording medium of this invention;

FIG. 11 shows processes in a third embodiment of a magnetic recording medium manufacturing method of the invention;

FIG. 12 shows processes in a fourth embodiment of a magnetic recording medium manufacturing method of the invention;

FIG. 13 shows an explanation of comparing processes using the first embodiment and the fourth embodiment;

FIG. 14 shows the configuration of a patterned medium of the prior art;

FIG. 15 shows the configuration of a patterned medium of the prior art;

FIG. 16 explains problems with the technology of the prior art; and

FIG. 17 explains the patterned medium of the prior art, shown in FIG. 15.

### DESCRIPTION OF EMBODIMENTS

Below, embodiments of the invention are explained, in the order of the configuration of a magnetic recording/reproduction device; a first embodiment of a magnetic recording medium; a second embodiment of a magnetic recording medium; a first embodiment of a method of manufacture of a magnetic recording medium; a second embodiment of a method of manufacture of a magnetic recording medium; a third embodiment of a method of manufacture of a magnetic recording medium; a fourth embodiment of a method of manufacture of a magnetic recording medium; and other embodiments. However, this invention is not limited to these embodiments.

(Magnetic Recording/Reproduction Device)

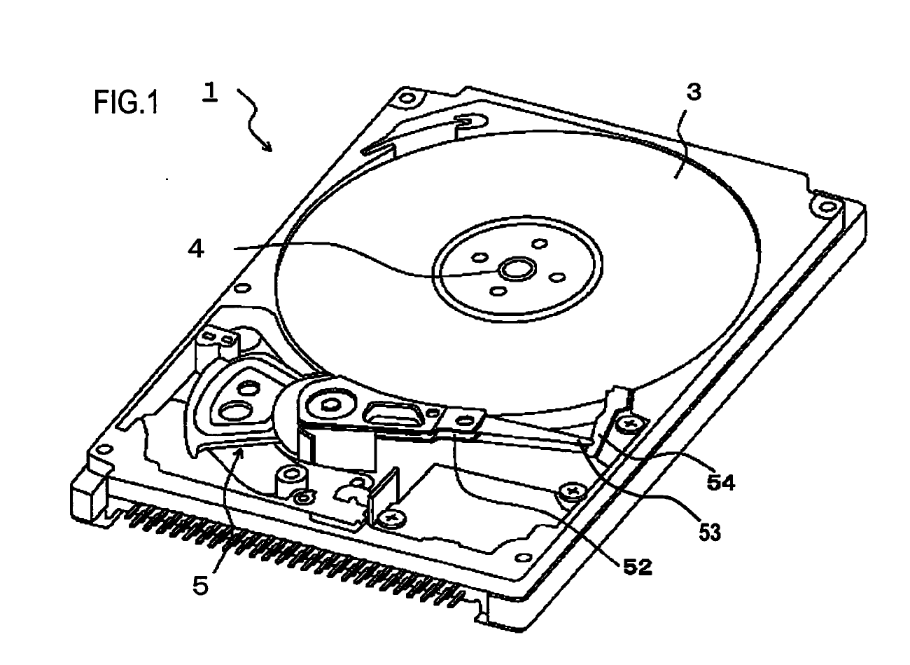

FIG. 1 is an external view of one embodiment of a magnetic recording/reproduction device of this invention. FIG. 1 shows a magnetic disk device (hard disk drive) as an example of a magnetic recording/reproduction device.

As shown in FIG. 1, in the disk enclosure (also called a DE) 1, a magnetic disk 3 which is a magnetic recording medium is provided on the rotating shaft of a spindle motor 4. The spindle motor 4 rotates the magnetic disk 3. The actuator (also called a VCM) 5 has an arm (also called a head actuator) 52 and a magnetic head 53 on the suspension tip, and moves the magnetic head 53 in the radial direction of the magnetic disk 3.

The actuator 5 has a voice coil motor (VCM) which rotates the rotating shaft about its center. In FIG. 1, the magnetic disk device is equipped with a single magnetic disk 3, and two magnetic heads 53 are driven simultaneously by the same actuator 5.

A magnetic head 53 has a read element and a write element. A magnetic head 53 is formed by layering a read element comprising a magnetoresistance (MR) element on a slider, and then layering a write element comprising a write coil thereupon.

On the outside of the magnetic disk 3 is provided a ramp mechanism 54 for retraction and parking the magnetic heads 53 from the magnetic disk 3.

In the bottom of FIG. 1, a printed circuit assembly (control circuit portion) is provided; on the printed circuit assembly are provided a hard disk controller (HDC), microcontroller (MCU), read/write channel circuit (RDC), servo controller circuit, data buffer (RAM), and ROM (read-only memory). As the magnetic disk 3, a patterned medium described below is employed, and the magnetic heads 53 comprise a perpendicular recording head.

### First Embodiment of Magnetic Recording Media

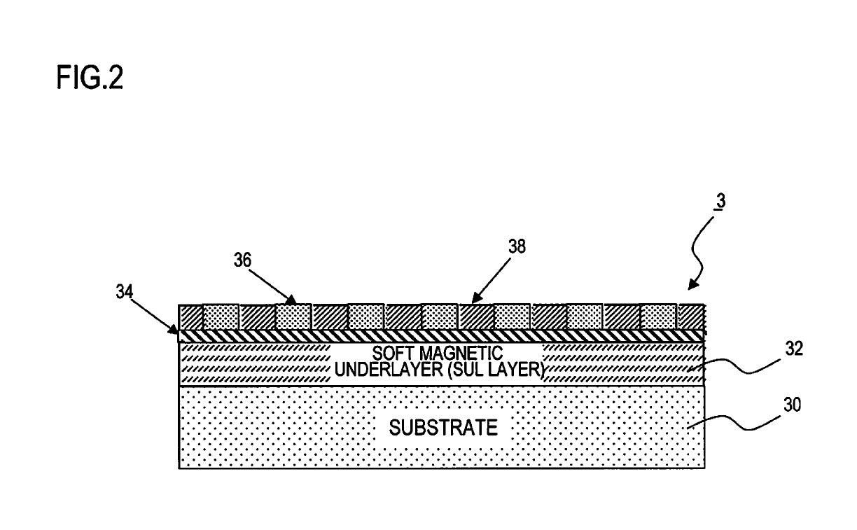

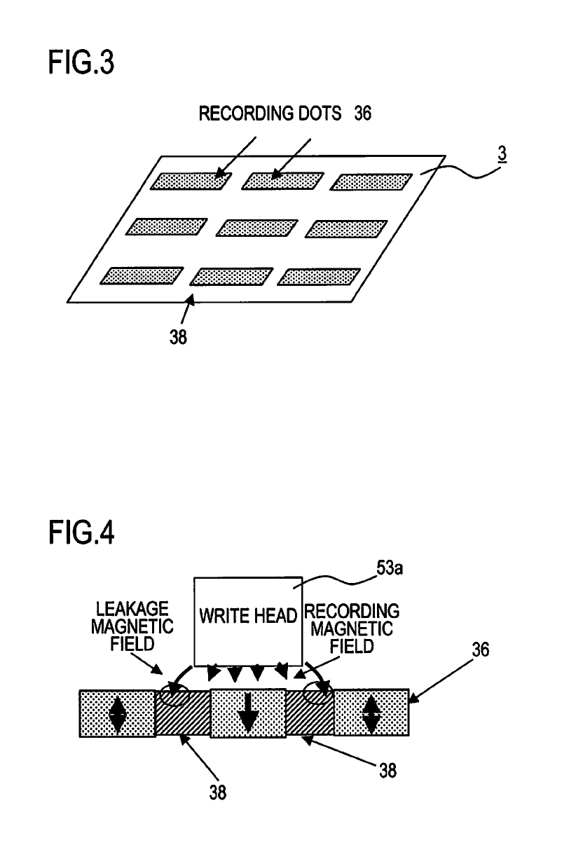

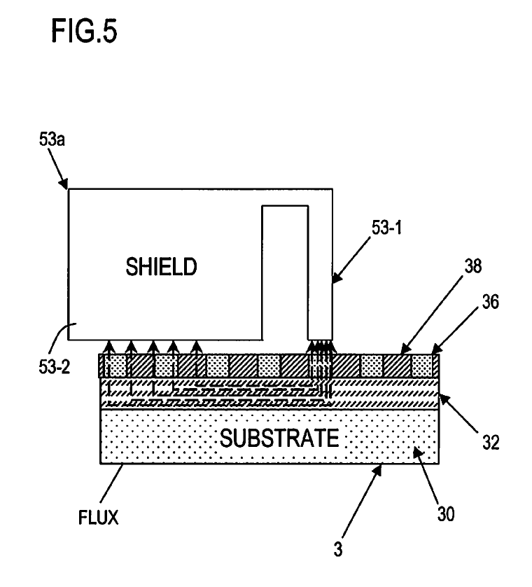

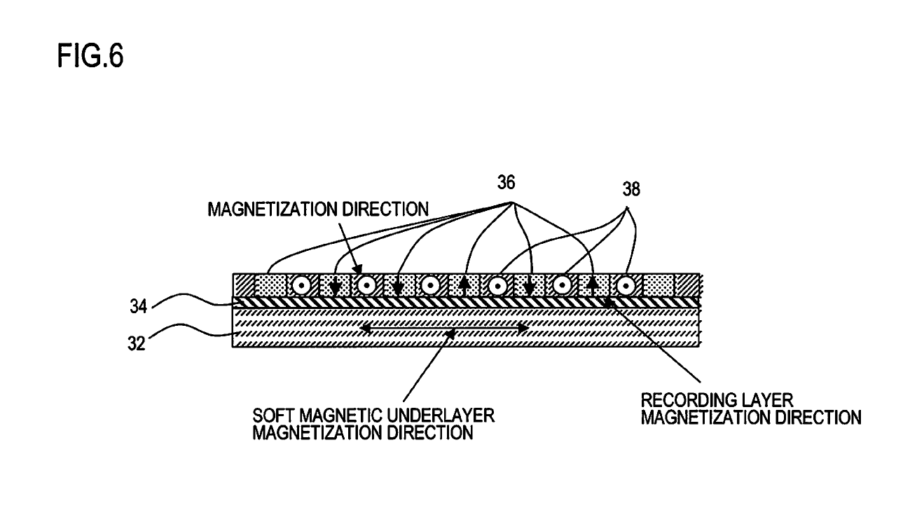

FIG. 2 is a cross-sectional view of a first embodiment of a magnetic recording medium of the invention, FIG. 3 is a perspective view of FIG. 2, FIG. 4 explains the side erasure suppression effect of the configuration in FIG. 2, FIG. 5 explains magnetic flux in perpendicular recording, and FIG. 6 explains the magnetization direction for the configuration in FIG. 2.

As shown in FIG. 2, the magnetic recording medium 3 has a multilayer structure in which are provided, on a substrate 30, a soft magnetic backing layer 32, nonmagnetic intermediate layer 34, and magnetic recording layer (hard magnetic material) 36. As also shown in FIG. 3, the magnetic recording layer 36 is partitioned by the soft magnetic film 38 to form recording dots. It is desirable that the coercivity of the soft magnetic film 38 be lower than that of the magnetic recording layer 36, at approximately 100 Oe (Oersteds), and that the magnetization direction be in a direction parallel to the substrate plane (an in-plane direction).

As the method of formation of the soft magnetic layer 38, a pattern is formed in the above-described multilayer structure film by using etching or another method to remove one layer, or two or more layers, and then using a sputtering method or similar to deposit soft magnetic material 38 onto portions where material has been removed. Then the excess soft magnetic layer 38 is removed, and finally surface flattening is performed.

As the substrate 30, it is desirable that a glass substrate be used, with a chromium alloy film provided as an underlayer on the glass substrate 30 to improve close adhesion to the glass substrate. As the soft magnetic backing layer 32, it is desirable that an APS-SUL structure (Anti-Parallel-Structure magnetic Soft Under Layer) multilayer film, comprising Co alloy/Ru/Co alloy, be used. An Ru layer is used as the intermediate layer 34, and a Co alloy perpendicular magnetization film is used as the magnetic recording layer 36.

As the soft magnetic material 38, an NiFe alloy, CoNiFe alloy, or similar is used. If necessary at this time, a magnetic field is applied during sputter film deposition.

By means of such a configuration, as shown in FIG. 4, even when intervals between dots are decreased, the leakage magnetic field from the magnetic head (write head) 53a is absorbed by the soft magnetic layer 38 between bits 36, and the leakage field can be prevented from affecting adjacent dots 36. Hence the problem of side erasure is resolved.

Further, the soft magnetic layer 38 and soft magnetic backing layer 32 are also separated, and the patterned media structure is suitable for high-density recording. Further, heat treatment is unnecessary, so that there is considerable freedom in choosing the film structure, substrate, and film materials.

As shown in FIG. 5, in the perpendicular magnetic recording method, the flow of magnetic flux between the magnetic pole 23-1 of the write head 23 and the shield 23-2 of the write head 23 passes through the magnetic recording layer 38 and underlayer on the substrate 3, and through the soft magnetic backing layer 32. Here, magnetic flux in the perpendicular direction toward the magnetic recording layer 38 is directed in a parallel direction in the soft magnetic backing layer 32, and is dispersed toward the shield 23-3 in the perpendicular direction.

As shown in FIG. 6, the soft magnetic layer 38 and soft magnetic backing layer 32 are separated by the nonmagnetic underlayer 34, so that the magnetization direction in the soft magnetic backing layer 32, which moves during recording, does not affect the magnetization in the soft magnetic layer 38. Hence the magnetization direction in the soft magnetic layer 38 between bits is always stable, and even though the magnetic recording layer 36 is separated by the soft magnetic layer 38, there is no effect on recording characteristics, and side erasure can be suppressed.

Due to the layer shape, the magnetization in the soft magnetic layer 38 between bits is easily directed in the perpendicular direction; but because the magnetic characteristics (anisotropy) resulting from formation by sputtering or other methods are excellent, the magnetization is in an in-plane direction. Hence the magnetization in the soft magnetic layer 38 does not affect the magnetization direction in the magnetic recording layer 36.

In this way, a soft magnetic layer 38 is provided between recording dots 36, the leakage magnetic field directed toward adjacent dots from the recording magnetic field generated during recording is absorbed by the soft magnetic layer, and side erasure can be suppressed. Moreover, the soft magnetic layer 38 and soft magnetic backing layer 32 are separated by the nonmagnetic underlayer 34, so that a highly reliable patterned medium with fewer record/reproduce errors can be provided. And, by inserting a soft magnetic layer, dot intervals can be further reduced, and a patterned medium which is highly reliable at high recording densities can be provided.

### Second Embodiment of Magnetic Recording Media

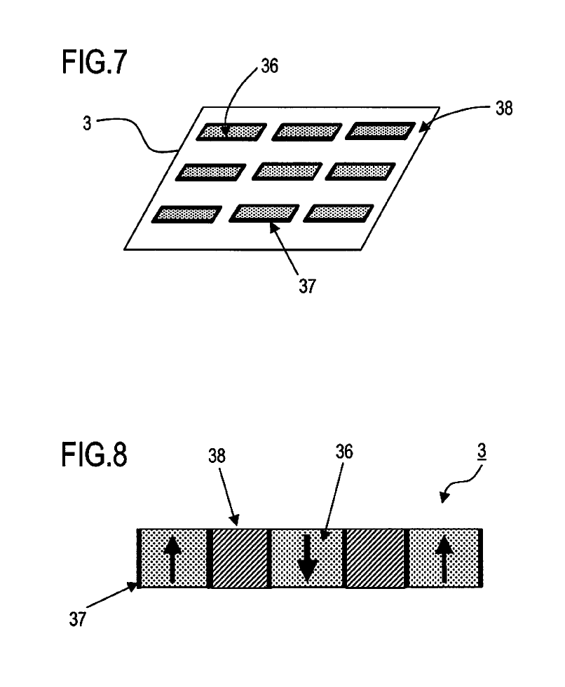

FIG. 7 is a perspective view of a second embodiment of a magnetic recording medium of this invention, and FIG. 8 is a cross-sectional view of FIG. 7, showing only the recording layer and soft magnetic layer portions in FIG. 2 and FIG. 6.

As shown in FIG. 7 and FIG. 8, in addition to the configuration of the above FIG. 2 and FIG. 6, a nonmagnetic layer 37 is enclosed between the soft magnetic layer 38 and the magnetic recording layer 36.

That is, as shown in FIG. 2 and FIG. 6, in a magnetic recording medium with a multilayer structure, in which are provided, on a substrate 30, a soft magnetic backing layer 32, nonmagnetic intermediate layer 34, and magnetic recording layer (hard magnetic material) 36, recording dots are formed in the magnetic recording layer 36, partitioned by a soft magnetic film 38. In this configuration, a nonmagnetic layer 37 is enclosed between the soft magnetic layer 38 and the magnetic recording layer 36.

By means of this configuration, magnetic coupling between the soft magnetic layer 38 and the magnetic recording layer 36 can be decreased, and the recording magnetic field distribution can be made sharp. As a result, the medium is suited to higher-density recording.

### First Embodiment of a Method of Manufacture of Magnetic Recording Media

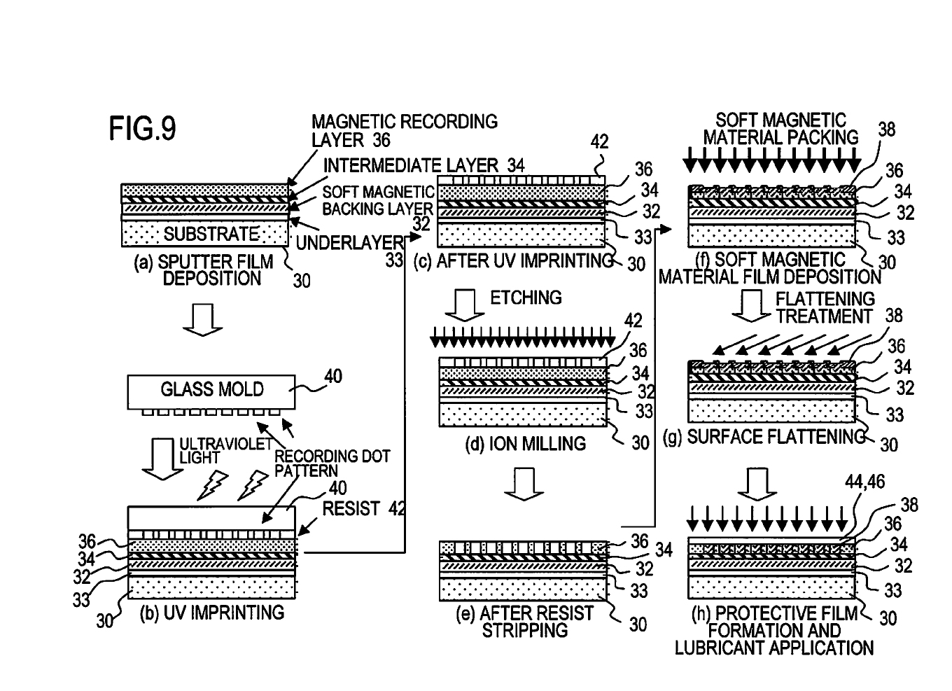

FIG. 9 shows processes in a first embodiment of a method of manufacture of a magnetic recording medium of this invention. FIG. 9 shows a method of manufacture of the magnetic recording medium of the first embodiment, explained in FIG. 2 and FIG. 3.

(a) Sputter film deposition process: A sputtering method is used to deposit a multilayer film on a glass substrate 30 for use in a 2.5″ HDD (Hard Disk Drive). As the structure of the multilayer film, an underlayer 33, soft magnetic backing layer 32, intermediate layer 34, and magnetic recording layer 36 are deposited in order from the side of the substrate 30. Each of the layers in this structure is not necessarily a single layer, but may be a multilayer film.

In this embodiment, a chromium alloy film was used as the underlayer 33; a Co alloy/Ru/Co alloy APS-SUL (Anti-Parallel Structure magnetic Soft Under Layer) structure multilayer film was used as the soft magnetic backing layer 32; an Ru layer was used as the intermediate layer 34; and a Co alloy perpendicular magnetization film was used as the magnetic recording layer 36.

(b), (c) UV imprinting processes: A resist 42 (ultraviolet-curing resin or similar) is applied onto the magnetic recording layer sample 36 deposited by sputtering. UV (ultraviolet) imprinting are performed by using a glass mold 40 on which a recording pattern is formed as a convex pattern by which an electron beam lithography device or similar is used to draw a data region and servo pattern. That is, the mold 40 is pressed against the resist (UV-curing resist or similar) 42 applied onto the sample deposited by sputtering, irradiation with ultraviolet rays is performed, and the pattern is transferred to the resist 42.

As the method of transfer of the mold pattern to the resist 42, in addition to the UV imprinting method, a thermal imprinting method can be used in which the resist is softened by heating, the mold 40 is then pressed onto the resist, and the pattern is transferred. A drawing method can also be used in which the resist 42 is applied to the sample after sputter film deposition, and an electron beam lithography device is used to draw pattern directly. This method requires time for drawing, and is not suited to mass production.

(d) Ion milling process: An ion milling method is used as an etching method, employing the resist 42 as a mask to etch the magnetic recording layer 36, forming a relief pattern in the magnetic recording layer 36 by means of the pattern of the resist 42. As the etching method, in addition to ion milling, reactive etching and other methods can be applied. If necessary, etching can be performed to midway through the magnetic recording layer 36, or until the layer below the magnetic recording layer 36.

(e) Resist stripping process: By removing the resist 42 using a solvent or similar, a dot pattern (relief pattern) is formed in the magnetic recording layer 36.

(f) Soft magnetic material deposition process: A sputter film deposition method or similar is used to deposit soft magnetic material 38 on the sample (magnetic recording layer 36), to fill the concave portions of the magnetic recording layer 36 with the soft magnetic material 38. As the soft magnetic material 38, an NiFe Alloy, CoNiFe alloy, or similar is used. If necessary, a magnetic field is applied during sputter film deposition.

(g) Surface flattening process: In order to remove soft magnetic material 38 overflowing on the surface, flattening treatment is performed. As flattening treatment, CMP (Chemical-Mechanical Polishing), mechanical polishing, low-angle milling, a gas cluster ion beam method, or similar can be employed. After polishing, the sample surface must have a flatness enabling flight of a magnetic head 53. In this embodiment, measurements using an atomic force microscope (AFM; manufactured by Veeco Limited) indicated that the center-line average roughness (Ra) was less than 1 nm.

(h) Protective film formation and lubricating oil application process: A sputter deposition method is used to deposit carbon as a protective film 44, after which a lubricant 46 is applied by an immersion method.

In this way, the magnetic recording medium of the first embodiment explained using FIG. 2 and FIG. 3 can be manufactured without heat treatment processes.

### Second Embodiment of a Method of Manufacture of Magnetic Recording Media

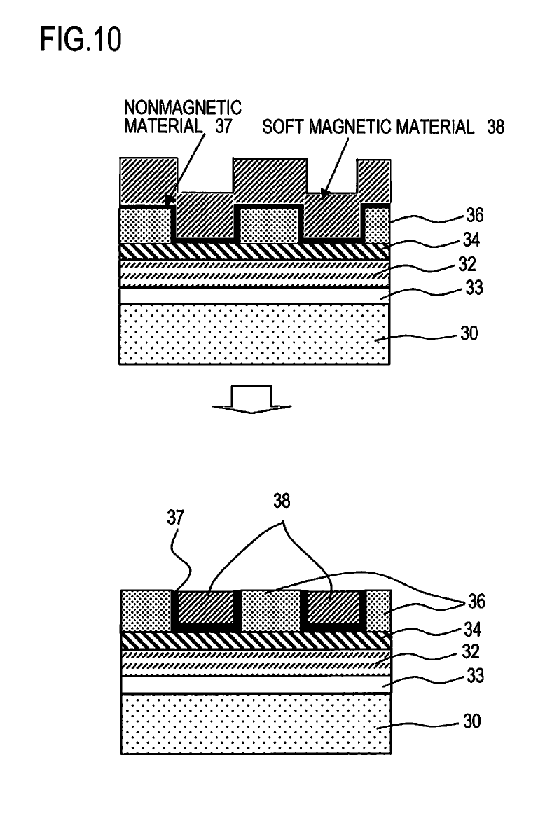

FIG. 10 shows processes in a second embodiment of a method of manufacture of a magnetic recording medium of this invention. FIG. 10 shows a method of manufacture of the magnetic recording medium of the second embodiment, explained in FIG. 7 and FIG. 8.

The following explanation also refers to FIG. 9. The method of fabrication in which a nonmagnetic layer 37 is enclosed between the magnetic recording layer 36 and the soft magnetic layer 38 in FIG. 7 and FIG. 8 modifies the soft magnetic material deposition process (f) of FIG. 9.

That is, in this method, when using a sputtering method in the film deposition process (f) to fill concave portions with soft magnetic material 38, in place of the soft magnetic material 38 a two-layer structure film of nonmagnetic material 37/soft magnetic layer 38 is deposited. In this case, the processes following film deposition are the same processes as the surface flattening process (g) and the protective film formation and lubricating oil application process (h) of FIG. 9. At this time, the deposited nonmagnetic layer 38 remains below the soft magnetic layer 36, and the magnetic recording medium of the second embodiment explained using FIG. 7 and FIG. 8 can be manufactured without heat treatment processes.

### Third Embodiment of a Method of Manufacture of Magnetic Recording Media

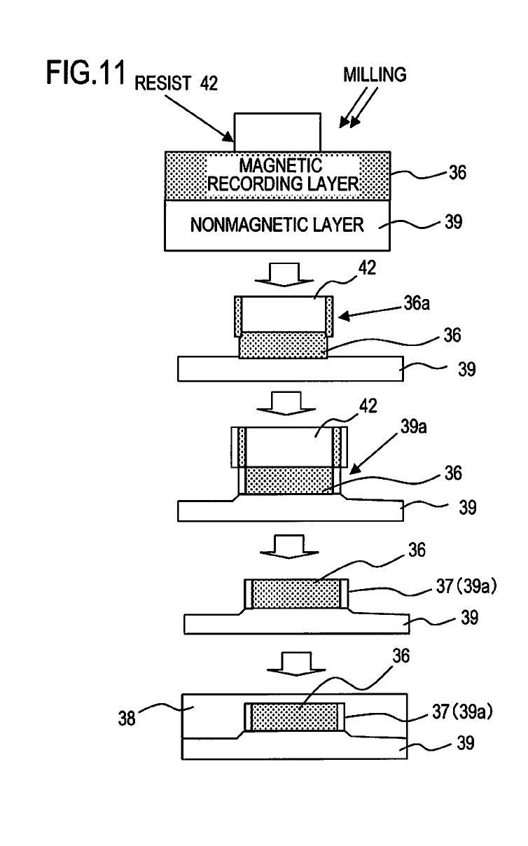

FIG. 11 shows processes in a third embodiment of a magnetic recording medium manufacturing method of the invention. FIG. 11 shows a method of manufacture of the magnetic recording medium of the second embodiment, explained using FIG. 7 and FIG. 8.

The following explanation also refers to FIG. 9. As a method of fabricating a structure in which a nonmagnetic layer 37 is enclosed between the magnetic recording layer 36 and soft magnetic layer 38 in FIG. 7 and FIG. 8, the ion milling process (d) of FIG. 9 is modified. That is, a method is utilized which employs re-adhesion of etched material, which occurs during pattern etching by the ion milling device.

It is known that when using an ion milling device to perform etching, the etched material adheres to the side walls of the pattern formed by etching. For example, in Japanese Patent Laid-open No. 2005-267736, a method is used in which magnetic material is made to adhere to resist to form protrusions, and flatness is controlled in the flattening process.

In this embodiment, a nonmagnetic layer 39 is provided as the layer below the magnetic recording layer 36 in the example shown in FIG. 11, and the above-described milling process is executed. In this milling process, when milling the magnetic recording layer 36, etched material of the magnetic recording layer 36 adheres to the side faces of the resist 42. Further, after milling of the magnetic recording layer 36, ion milling of the nonmagnetic layer 39 is performed, and nonmagnetic material 39 is caused to adhere to the wall faces of the upper magnetic recording layer 36.

Thereafter, the resist stripping process (e) of FIG. 9 is performed, and in the soft magnetic material packing process (f), soft magnetic material 38 is deposited by a sputtering method or similar. The processes after film deposition are the same as the surface flattening process (g) and the protective film formation and lubricating oil application process (h) of FIG. 9.

### Fourth Embodiment of a Method of Manufacture of Magnetic Recording Media

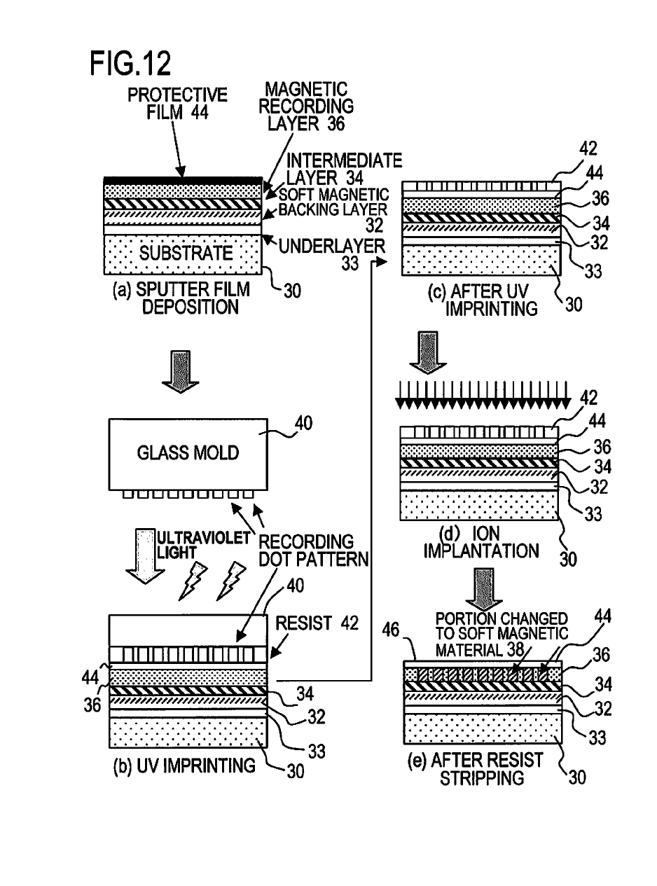

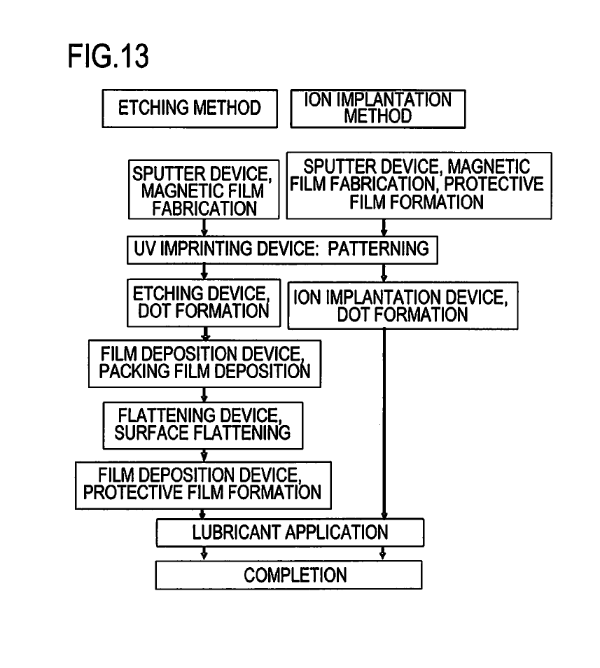

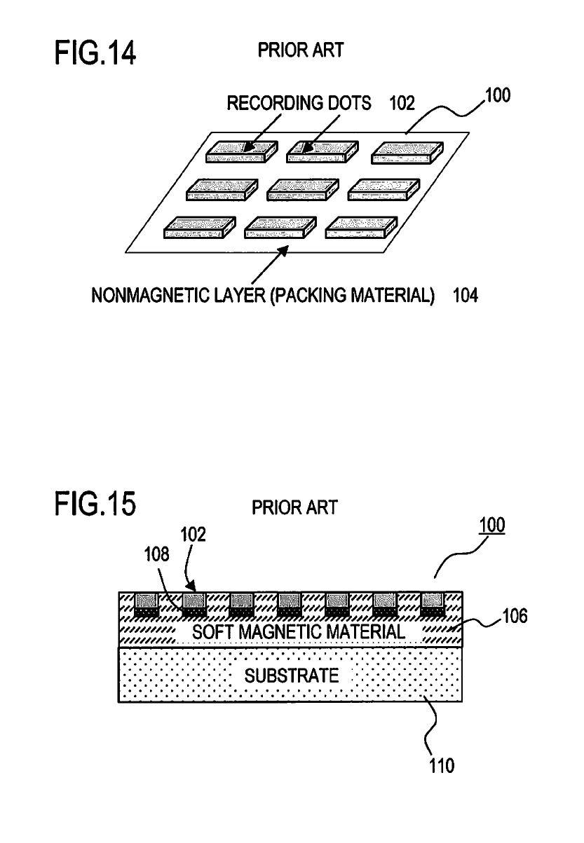

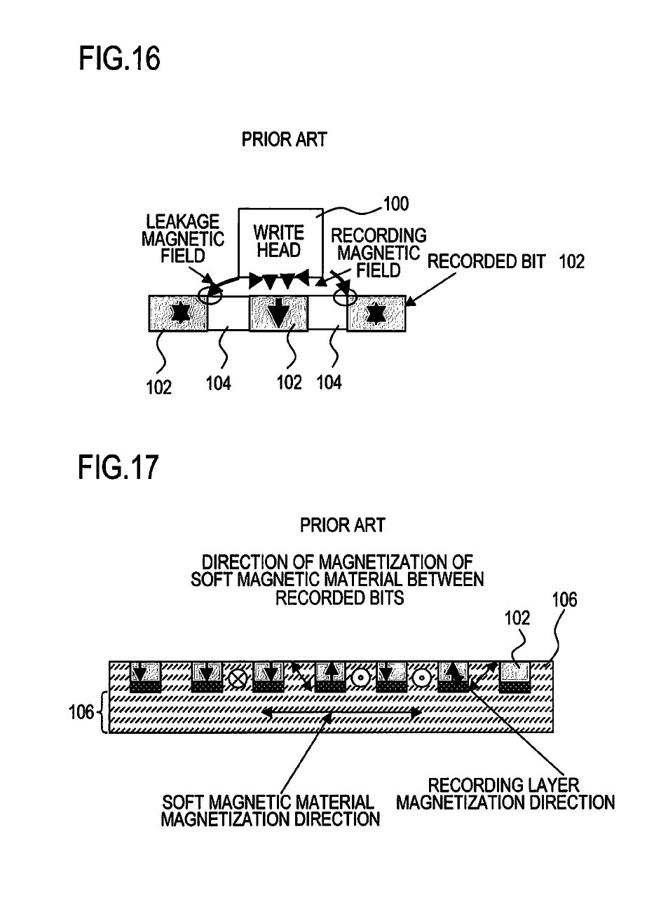

FIG. 12 shows processes in a fourth embodiment of a magnetic recording medium manufacturing method of the invention, and FIG. 13 shows an explanation of comparing processes using an etching method and using an ion implantation method. FIG. 12 shows a method of manufacture of the magnetic recording medium of the first embodiment, explained using FIG. 2 and FIG. 3.

FIG. 12 shows a method employing ion implantation as the method of forming the soft magnetic layer in a structure of this invention. In ion implantation, as for example disclosed in Japanese Patent Laid-open No. 2006-288085, magnetic material ions are implanted and are partially converted into hard magnetic material, to form a magnetization pattern.

On the other hand, in the case of this embodiment, an object is conversion into soft magnetic material of hard magnetic material, and nonmagnetic materials such as argon, oxygen, nitrogen, boron, phosphorus, and similar are used as ions for ion implantation. Through addition of impurities to the hard magnetic material (magnetic recording material) for ion implantation, and the effect of breaking the structure and similar, improvement of soft magnetic characteristics is possible.

As shown in FIG. 13, the ion implantation method does not have an etching process, so that there is no need for processes of filling grooves with soft magnetic material and of flattening ((f), (g), (h) in FIG. 9). Hence fewer manufacturing devices and fewer processes are required than when forming the pattern by etching as described above, and manufacturing costs can be reduced.

Details are explained using FIG. 12.

(a) Sputter film deposition process: A sputtering method is used to deposit a multilayer film on a glass substrate 30 for a 2.5 inch HDD (Hard Disk Drive). As the structure of the multilayer film, an underlayer 33, soft magnetic backing layer 32, intermediate layer 34, magnetic recording layer 36, and protective layer 44 are deposited in this order from the side of the substrate 30. Each layer need not be a single layer, but may be formed as a multilayer film.

In this embodiment, a chromium alloy film was used as the underlayer 33, an APS-SUL (Anti-Parallel Structure magnetic Soft Under Layer) structure multilayer film, comprising Co alloy/Ru/Co alloy, was used as the soft magnetic backing layer 32, an Ru layer was used as the intermediate layer 34, and a Co alloy perpendicular magnetization film was used as the magnetic recording layer 36.

(b), (c) UV imprinting processes: Resist 42 (ultraviolet-curing resin or similar) is applied onto the magnetic recording layer sample 36 deposited by sputtering. UV (ultraviolet) imprinting is performed by using a glass mold 40 on which a recording pattern is formed as a convex pattern by which an electron beam lithography device or similar is used to draw a data region and servo pattern. That is, the mold 40 is pressed against the resist (UV-curing resist or similar) 42 applied onto the sample deposited by sputtering, irradiation with ultraviolet rays is performed, and the pattern is transferred to the resist 42.

As the method of transfer of the mold pattern to the resist 42, in addition to the UV imprinting method, a thermal imprinting method can be used in which the resist is softened by heating, the mold 40 is then pressed onto the resist, and the pattern is transferred. A drawing method can also be used in which the resist 42 is applied to the sample after sputter film deposition, and an electron beam lithography device is used to draw pattern directly. This method requires time for drawing, and is not suited to mass production.

(d) Ion implantation process: An ion implantation method is used to implant ions (of argon, oxygen, nitrogen, boron, phosphorus, or other nonmagnetic molecules) into portions of the magnetic recording layer 36 at which the resist 42 has been removed, changing the magnetic recording layer (hard magnetic layer) 36 into a soft magnetic layer 38.

(e) Resist stripping process: After removing the resist 42 with a solvent or similar, an immersion method is used to apply a lubricant 46.

In this way, the ion implantation method does not have an etching process, so that fewer manufacturing devices and fewer processes are required than when forming the pattern by etching as described above, and manufacturing costs can be reduced.

### Other Embodiments

In the above-described embodiments, magnetic disk devices were explained which were equipped with one magnetic disk; but application to devices equipped with two or more magnetic disks is possible. In magnetic recording medium embodiments also, the medium is not limited to a disk shape, and application to other magnetic recording medium is possible; the form of the magnetic head is not limited to that of FIG. 5, and application to other separated-type magnetic heads is also possible.

Magnetic dots and a soft magnetic layer are provided on a soft magnetic underlayer with a nonmagnetic layer intervening, so that magnetic dots are separated by the soft magnetic layer, and consequently leakage flux during recording to magnetic dots is absorbed by the soft magnetic layer, side erasure can be suppressed, and moreover the soft magnetic underlayer and soft magnetic layer are separated, so that an influence on recording/reproduction characteristics can be prevented.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. A magnetic recording medium, comprising:
a substrate;
a soft magnetic backing layer, provided on the substrate;
a nonmagnetic layer, provided on the soft magnetic backing layer;
a magnetic recording layer, which is provided on the nonmagnetic layer and formed from a hard magnetic material, and which has a plurality of physically separated magnetic dots; and
a soft magnetic layer, provided on the nonmagnetic layer so as to surround the periphery of the magnetic dots of the magnetic recording layer.

2. The magnetic recording medium according to claim 1, wherein:
a direction of an easy axis of magnetization in the soft magnetic layer is parallel to the substrate, and
a direction of an easy axis of magnetization in the magnetic recording layer is perpendicular to the substrate.

3. The magnetic recording medium according to claim 1, wherein a nonmagnetic member is provided at a boundary between the magnetic dots and the soft magnetic layer.

4. The magnetic recording medium according to claim 1, wherein a coercive force of the soft magnetic layer is smaller than a coercive force of the magnetic recording layer.

5. The magnetic recording medium according to claim 1, wherein the magnetic recording layer comprises a perpendicular magnetization film.

6. A magnetic recording/reproduction device, comprising:
a magnetic recording medium;
an electromagnetic transducing element which reads data from and writes data to the magnetic recording medium; and
an actuator, which moves the electromagnetic transducing element to an arbitrary position of the magnetic recording medium,
wherein the magnetic recording medium comprises:
a substrate;
a soft magnetic backing layer, provided on the substrate;
a nonmagnetic layer, provided on the soft magnetic backing layer;
a magnetic recording layer, which is provided on the nonmagnetic layer and formed from a hard magnetic material, and which has a plurality of physically separated magnetic dots; and,
a soft magnetic layer, provided on the nonmagnetic layer so as to surround a periphery of the magnetic dots of the magnetic recording layer.

7. The magnetic recording/reproduction device according to claim 6, wherein:
a direction of an easy axis of magnetization in the soft magnetic layer is parallel to the substrate, and
a direction of an easy axis of magnetization in the magnetic recording layer is perpendicular to the substrate.

8. The magnetic recording/reproduction device according to claim 6, wherein a nonmagnetic member is provided at a boundary between the magnetic dots and the soft magnetic layer.

9. The magnetic recording/reproduction device according to claim 6, wherein a coercive force of the soft magnetic layer is smaller than a coercive force of the magnetic recording layer.

10. The magnetic recording/reproduction device according to claim 6, wherein the magnetic recording layer comprises a perpendicular magnetization film.

11. The magnetic recording/reproduction device according to claim 6, wherein:
the magnetic recording medium comprises a magnetic disk,
and the electromagnetic transducing element comprises a read element which reads data from the magnetic disk and a write element which writes data to the magnetic disk.

12. A method of manufacturing a magnetic recording medium, comprising:
a first step of depositing on a substrate a soft magnetic backing layer, nonmagnetic layer, and magnetic recording layer formed of a hard magnetic material;
a second step of applying resist to the magnetic recording layer deposited on the substrate, and forming a pattern in the resist to form a plurality of physically separated magnetic dots; and
a third step of using either etching or ion milling to form a soft magnetic layer on the nonmagnetic layer so as to surround peripheries of the magnetic dots of the magnetic recording layer, through the patterned resist.

13. The method of manufacturing a magnetic recording medium according to claim 12, wherein the third step comprises:
a step of etching the magnetic recording layer through the patterned resist;
a step of stripping away the resist; and
a step of forming a soft magnetic layer on the nonmagnetic layer so as to surround peripheries of the magnetic dots of the magnetic recording layer.

14. The method of manufacturing a magnetic recording medium according to claim 12, wherein the third step comprises a step of ion implantation of nonmagnetic material atoms into the magnetic recording layer through the patterned resist, to modify the layer to soft magnetic material, and a step of stripping away the resist.

15. The method of manufacturing a magnetic recording medium according to claim 13, wherein the step of forming the soft magnetic layer comprises a step, with respect to the magnetic recording layer subjected to the etching, of forming the nonmagnetic material and the soft magnetic material on the nonmagnetic layer so as to surround peripheries of the magnetic dots of the magnetic recording layer.

16. The method of manufacturing a magnetic recording medium according to claim 13, wherein the step of etching the magnetic recording layer comprises:
a step of using an ion milling method to abrade the hard magnetic material and lower nonmagnetic material through the resist; and
a step of causing re-adhesion of nonmagnetic material, occurring at the time of milling of the lower nonmagnetic material, to side walls of the pattern formed in the magnetic recording layer, and forming the nonmagnetic material on peripheries of the magnetic dots.
